(19) United States
(12) Patent Application Publication
(10) Pub. No.: US 2008/0010157 A1
(43) Pub. Date: Jan. 10, 2008

(54) Deploying Advertisement Objects With Vendor Transaction Objects

(76) Inventors: Raj Prakash, Saratoga, CA (US); Uday Pundalik Kurkure, Los Altos Hills, CA (US)

Correspondence Address: Raj Prakash, 20585 Carniel Avenue, Saratoga, CA, 95070, US

(21) Appl. No.: 11/766,796

(22) Filed: Jun. 22, 2007

Related U.S. Application Data
(60) Provisional application No. 60/806,779, filed on Jul. 8, 2006.

(51) Int. Cl. G06Q 30/00

(52) U.S. Cl. 705/14

(57) ABSTRACT

An advertising network brings advertising partners together with advertisers to efficiently and intelligently deploy advertisements. Information is collected from advertisers and advertising partners that describe their attributes. Advertisements are deployed based, at least in part, on this attribute information. The advertising partners engage in transactions (e.g., transmitting invoices, transmitting receipts, referring services and/or goods, etc.) with a number of customers, clients, friends, etc. For a vendor initiated transaction, a vendor is registered as an advertising partner source end-point. Advertisements objects that correspond to attributes of the source end-point (and possibly other criteria, such as an advertising policy defined by an advertiser) are deployed to a destination end-point(s) of the transaction, such as a customer of the vendor, with a receipt or an invoice.

### CROSS REFERENCE TO RELATED PATENT APPLICATIONS

This non-provisional patent application claims benefit of the earlier filing date under 35 U.S.C. §119(e) of the Provisional Patent Application No. 60/806,779 filed on Jul. 8, 2006 and incorporates the Provisional Patent Application in its entirety.

### BACKGROUND

1. Field of the Invention

In general, the present application relates to advertising. More specifically, the present application relates to an online invoice/receipt service based distributed advertising.

2. Description of the Related Art

Businesses with a web presence advertise on the Internet with links to their websites. These link advertisements are displayed on search results pages and on other web pages, such as blogs. The displayed links are either based on search keywords entered by an end-user or keyword content of a web page.

Advertisers bid for keywords auctioned by companies, such as Google Inc. and Yahoo! Inc. When an advertisement keyword is encountered (i.e., is detected in a web page or entered by a user), the advertisement links are displayed in accordance with the highest bidder(s) and relevancy. The advertisement distribution company (e.g., Google Inc. or Yahoo! Inc.) then charges a client based on clicks on the advertisement links.

### SUMMARY

It has been discovered that end-point attribute based advertising allows for efficient and targeted advertising. One or more advertisement objects and/or indications of the advertisement objects are transmitted with an object of a transaction (e.g., a word processing document, a portable document format file, an e-mail message, etc.). The advertisement objects correspond to one or more attributes of a source end-point of the transaction (e.g., a sender of an e-mail message). Examples of a source end-point of a transaction include a company that generates a receipt for a good or service purchased, that generates a purchase order, that generates an invoice for a payment of a good or service, etc. A transaction confirmation advertising service drives the source end-point attribute based advertising. A company registers with the transaction confirmation advertising service as a vendor. Advertisement objects are supplied to the vendor or are maintained for the vendor. Since the vendor is the source end-point that generates transaction confirmation objects (e.g., receipts, purchase orders, invoices, etc.), advertisement objects correspond to one or more attributes of the vendor (e.g., type of business, clients of the vendor, service provided, etc.). Whether integrated into an e-mail message, supplied as a PDF file, or printed and mailed, a transaction confirmation object is associated with the advertisement objects. The associated advertisement objects are conveyed with the transaction confirmation object. Advertisements are tracked based on the vendor and the customer of the vendor (i.e., transaction confirmation object destination). The vendor is compensated in accordance with the recorded tracking information.

Another vehicle for advertising is selection by a source end-point. A user selects one or more advertisement objects relevant to an online communication (e.g., e-mail message, instant message, etc.) or believed to be of interest to a destination end-point. The selected advertisement objects are transmitted to the destination end-point. The destination end-point may further propagate the advertisement by forwarding the advertisement objects to another destination end-point.

### BRIEF DESCRIPTION OF THE DRAWINGS

The present invention may be better understood, and its numerous objects, features, and advantages made apparent to those skilled in the art by referencing the accompanying drawings.

FIG. 1 depicts an example of various services that leverage an advertisement store.

FIG. 2 depicts an example flowchart for end-point attribute based advertising.

FIG. 3 depicts an example invoice transaction of an invoice-advertising service with referential embedding of an advertisement object.

FIG. 4 depicts an example invoice transaction of an invoice-advertising service with literal embedding of an advertisement object.

FIG. 5 depicts an example invoice from a school.

FIG. 6 depicts an example invoice from a school with embedded advertisement objects.

FIG. 7 depicts an example invoice for optometry services.

FIG. 8 depicts an example optometrist invoice with advertisement objects embedded.

FIG. 9 depicts an example invoice from a property inspection center.

FIG. 10 depicts an example invoice for a motel.

FIG. 11 depicts an example advertisement tracking mechanism.

FIG. 12 depicts propagation of new advertising partner information through an advertising facilitation entity.

FIG. 13 depicts the example advertising facilitation entity being updated with information for an advertiser.

FIG. 14 depicts an example registration exchange between an advertising facilitation entity and an advertising partner.

FIG. 15 depicts an example exchange for registration of an advertiser.

The use of the same reference symbols in different drawings indicates similar or identical items.

### DESCRIPTION OF EMBODIMENT(S)

The description that follows includes exemplary systems, methods, techniques, instruction sequences and computer program products that embody techniques of the present invention. However, it is understood that the described invention may be practiced without these specific details. For instance, the following description refers to an invoice-advertising service and associating advertisement objects with invoices. However, advertisement objects may also be associated with receipts generated by vendors, or more generally, associated with transaction confirmation objects. In other instances, well-known instruction instances, protocols, structures and techniques have not been shown in detail in order not to obfuscate the description.

Overview

Aggregating advertisement objects and maintaining the aggregated advertisement objects in one or more stores accessible via one or more communications media allows for efficient deployment of advertisement objects and targeted advertising. The one or more stores are maintained as a single logical point (“advertising facilitation entity”). Maintaining advertisements objects and policies that govern deployment of the advertisements objects and/or advertising campaigns to be applied across advertisement objects at a single logical point of coherency allows for flexibility and agility in advertising. Maintaining the stores of advertisement objects and/or advertising policies accessible via a communications media allows the flexibility and agility to be realized in various manners, such as deploying the advertisement objects in accordance with any governing policies across a wide array of outlets, such as print, Internet, radio, television, etc.

Advertisement objects based on an attribute of an end-point of a transaction can be deployed from the advertisement object store(s) for intelligent targeted advertising. Advertisements objects are selected and/or supplied from the store(s), based on attributes of one or both of a source end-point and a destination end-point of a transaction. From the perspective of the advertisement object store(s), an end-point is a user entity and an associated communication identifier. For example, an end-point may be a network identifier (e.g., IP address, Ethernet address, and port, etc.) and identifying information of a company (e.g., company name, company security key, etc.). Another example of an end-point is a mobile phone number and a user name. One or more attributes are associated with the end-point. For example, one or more stores host attributes (e.g., business type, subject matter of interest, etc.) associated with end-points. The stores are populated with this information upon registration of an end-point. For example, a user may register via their mobile communication device with the advertising facilitation entity. During registration, the user may be required to indicate areas of interest (e.g., entertainment products such as audio and video devices, computers, gardening, dating, etc.). In another example, a company registers with the advertising facilitation entity. Registration would require indication of a business category and, perhaps, sub-categories, or even complimentary types of businesses.

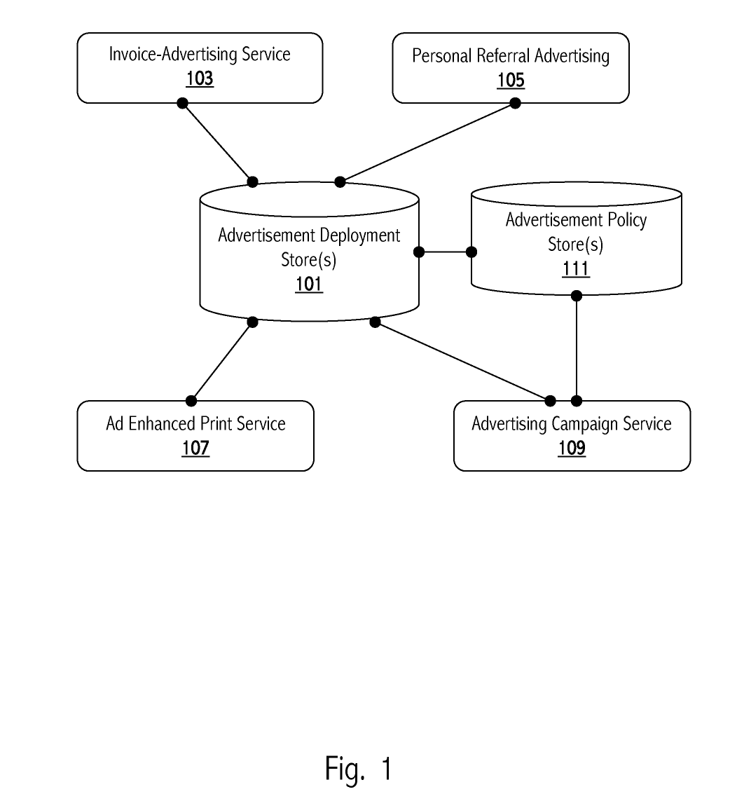

FIG. 1 depicts an example of various services that leverage an advertisement store. An advertisement store(s) 101 hosts advertisement objects for various advertisers. Examples of advertisement objects include web pages, banners, images (e.g., GIF, JPEG, etc.), audio files, video files, PDF files, word processing documents, text files, etc. Although depicted as one or more stores, those of ordinary skill in the art should appreciate that an aggregation of advertisement objects can be stored in accordance with any of a number and combination of protocols, applications, hardware configurations, etc. For instance, advertisement objects may be maintained in one or both of network attached storage and a storage area network. The advertisement objects may be stored in one or more directories, relational databases, hierarchical databases, object oriented databases, hybrid databases, hybrid of directories and databases, etc. Various services leverage the advertisement store(s) 101 for advertising. An invoice-advertising service module 103 leverages the advertisement store(s) 101. A referral-advertising module 105 and an advertisement-enhanced print service module 107 also leverage the advertisement store(s) 101. The advertisement store(s) 101 is coupled with an advertisement policy store(s) 111. An advertising campaign service module 109 leverages both the advertisement store(s) 101 and the advertisement policy store(s) 111. An advertising facilitation entity may exercise ownership and/or control over the advertisement object store(s) 101 and allow other entities to access the advertisement object store(s) 101 to provide the various services. The advertising facilitation entity may also provide a portion or all of the services that leverage the advertisement object store(s) 101.

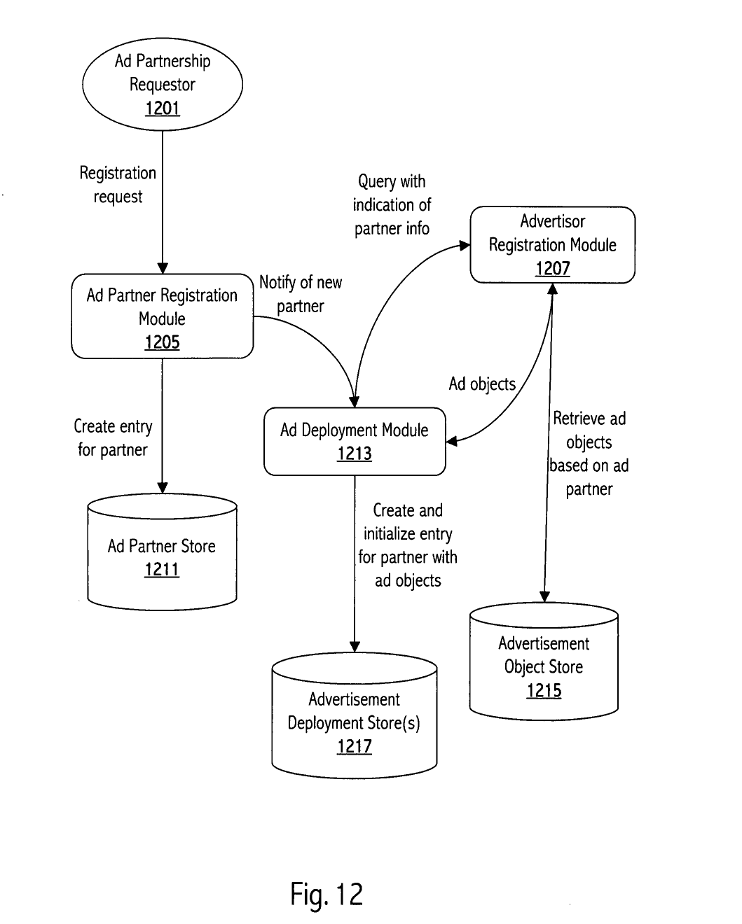

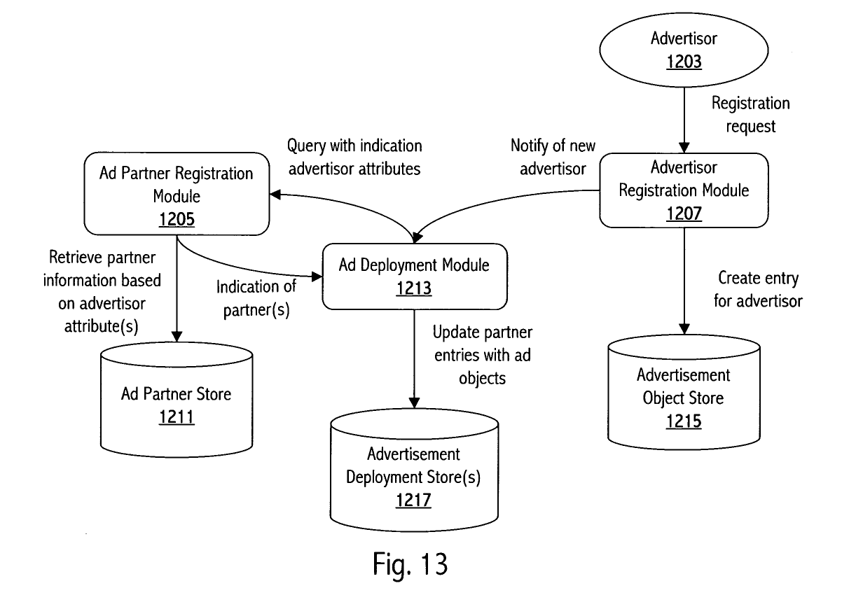

FIGS. 12 and 13 depict entities registering with an advertising facilitation entity. FIG. 12 depicts propagation of new advertising partner information through an advertising facilitation entity. An advertising partnership requester 1201 transmits a registration request to an advertising registration module 1205. The advertising registration module 1205 gathers information from the advertising partner 1201 and creates an entry in an advertising partner store 1211.

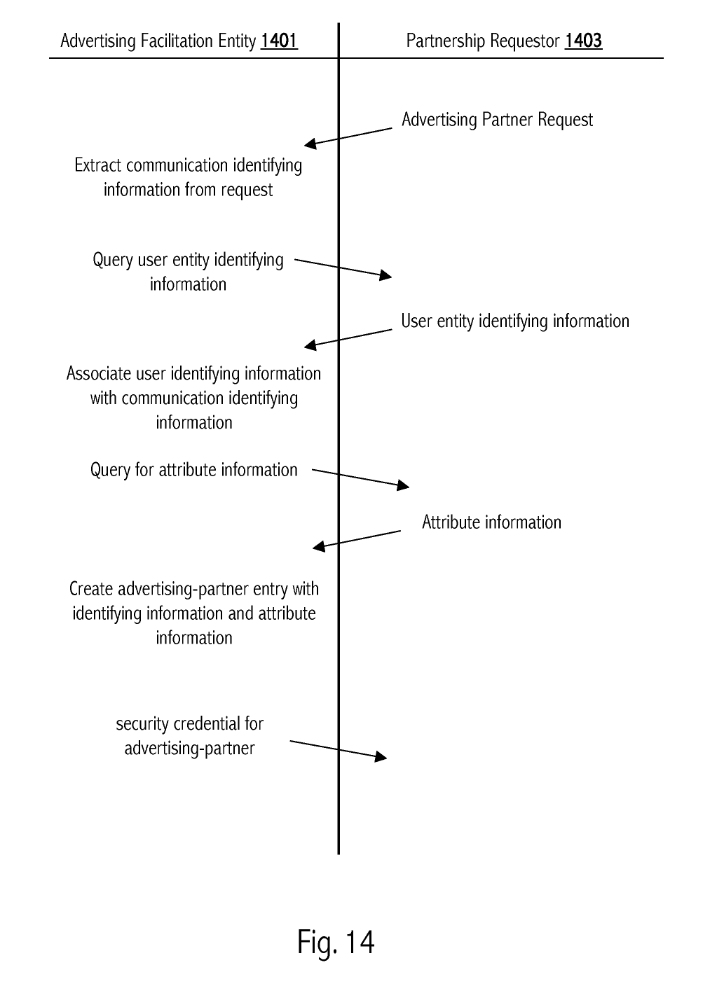

FIG. 14 depicts an example registration exchange between an advertising facilitation entity and an advertising partner. An advertising partnership requestor 1403 transmits an advertising partnership request to an advertising facilitation entity 1401. The advertising facilitation entity extracts communication identifying information (e.g., IP address, port, etc.) from the request. The advertising facilitation entity 1401 then queries the requestor 1403 for user entity identifying information (e.g., company name, company name and address, tax number, etc.). The requester 1403 supplies user entity identifying information responsive to the request from the advertising facilitation entity 1401. The advertising facilitation entity 1401 associates the user entity identifying information and the communication identifying information to establish an advertising partner identify for the requester 1403 (e.g., a hash is generated from the information, the information is concatenated, the information is concatenated and then the concatenation is converted to another format, etc.). Those of ordinary skill in the art will appreciate that a variety of techniques are available for establishing an identity for the requestor 1403 that is unique from the perspective of the advertising facilitation entity 1401. The advertising facilitation entity 1401 queries the requester 1403 for attribute information. The attribute information may indicate a business type or field of the requestor 1403, geographic location of the requestor 1403, areas of interest to the requestor 1403, business types or fields that are complimentary to the requestor 1043, number of customers, etc. In response to the query, the requestor 1403 supplies attribute information. The advertising facilitation entity 1401 then creates an advertising-partner entry for the requestor 1403 that indicates the advertising partner identifier and the attribute information. The advertising facilitation entity also creates a security credential(s) for the advertising partner and supplies the advertising credential(s) to the requester 1403. The advertising partner 1403 can utilize the security credential to satisfy one or more security mechanisms that may be implemented by the advertising facilitation entity to ensure integrity of the advertising network developed by the advertising facilitation entity 1401.

Referring again to FIG. 12, after the entry is created in the advertising partner store 1211 for the partnership requester 1201, the advertising partner registration module 1205 notifies an advertisement deployment module 1213. The advertisement deployment module 1213 queries an advertiser registration module 1207 with an indication of at least the attribute information of the partnership requestor 1201. The advertiser registration module 1207 retrieves advertisement objects from an advertisement object store 1215 in accordance with the indicated partner information from the advertisement deployment module 1213. For example, a request is submitted with parameters that indicate real estate services, tier A advertising partner, and Austin, Tex. The advertiser registration module 1207 will retrieve advertisement objects associated with real estate services and with Austin, Tex. Whether incorporated in the advertisement object store 1215 or stored elsewhere, the advertisement objects eventually supplied to the advertisement deployment module 1213 are further constrained by the qualification of the advertising partner as a tier A advertising partner, which reflects a higher grade of partner. For example, a tier A partner is an advertising partner that has exposure or access to more than 100,000 customers for deploying advertisements according to that advertising partners attribute information. Advertisement policies of advertisers will indicate which tier of advertising partner that are willing and/or capable of using. The indication of policy may be stored coextensively with the advertisement objects or separately as already stated. Hence, the advertisement objects retrieved from the advertisement object store 1215 may satisfy the search parameters. In another example, the advertisement objects retrieved from the advertisement object store 1215 satisfy non-policy related search parameters. Therefore, the retrieved objects are further filtered in accordance with any policy related parameters. The advertisement objects retrieved by the advertiser registration module 1207 are supplied to the advertisement deployment module 1213.

The advertisement deployment module 1213 may further filter the advertisement objects. For example, the advertisement deployment module may have constraints to be applied to advertisement objects supplied from the advertiser registration module 1207. For example, a set of 7 advertisement objects may be reduced to 4 advertisement object, perhaps because a limit of advertisement objects are applied for that particular partner (or a category of partners, all partners, etc.). The advertisement deployment module 1213 creates and initializes an entry in an advertisement deployment store(s) 1217 for the partner with the supplied advertisement objects. For example, the advertisement deployment module 1213 creates a path or updates a directory tree. The advertisement deployment module 1213 may also be responsible for generating an object that merges the individual advertisement objects into a single object or generating an object that references the individual advertisement objects, although such functionality may be implemented separately (e.g., an agent at the advertisement deployment store 1217, a server that maintains the store 1217, etc.).

FIG. 13 depicts the example advertising facilitation entity being updated with information for an advertiser. An advertiser 1203 transmits a registration request to the advertiser registration module 1207. The advertiser registration module 1207 gathers information from the advertiser 1203 to create an entry in the advertisement object store 1215.

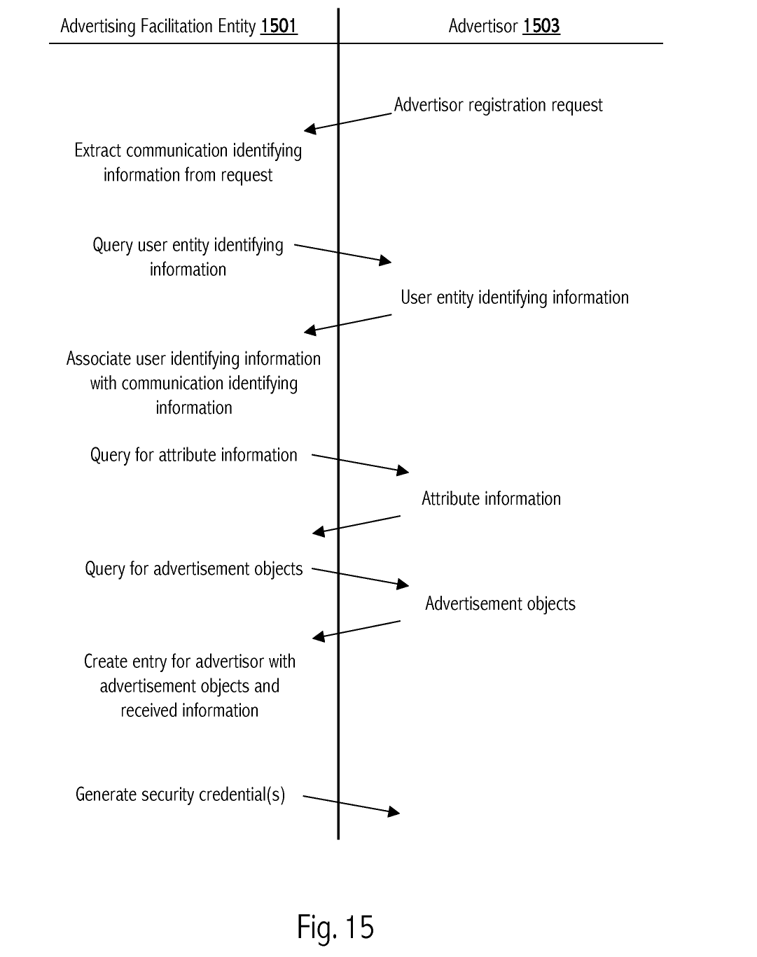

FIG. 15 depicts an example exchange for registration of an advertiser. An advertiser 1503 transmits a registration request to an advertising facilitation entity 1501. The advertising facilitation entity 1501 extracts communication identifying information from the request. The advertising facilitation entity 1501 queries the advertiser 1503 for user entity identifying information. The advertiser 1503 supplies user entity identifying information. The advertising facilitation entity 1501 associates the identifying information with each other, and then queries the advertiser 1503 for attribute information, such as business type, geography, target demographics, etc. The advertiser 1503 supplies the attribute information to the advertising facilitation entity 1501. The advertising facilitation entity 1501 creates an entry in an advertisement object store for the advertiser with the advertisements objects and collected information. Those of ordinary skill in the art should appreciate that the exchange is an example to aid in understanding embodiments and not meant to be limiting. For example, a single or more operations may be performed to collect information from an advertiser (e.g., the request includes communication and user entity identifying information, as well as attribute information).

Referring again to FIG. 13, the advertiser registration module 1207 notifies the advertisement deployment module 1213 of the new advertiser. The notification also indicates the attribute information. The advertisement deployment module 1213 queries the advertisement partner registration module 1205 for advertising partners that would be of interest to the advertiser 1203 according to the advertiser's registered information. Indication(s) of one or more advertising partners that at least partially satisfy the submitted criteria are returned to the advertisement deployment module 1213. If appropriate, the advertisement deployment module 1213 updates an entry of an indicated partner with at least one of the advertisement objects of the new advertiser. Of course, the advertisement deployment module may determine that no update is appropriate after comparing advertisement policies of the new advertiser and current advertisers corresponding to the indicated partner. For example, a current advertiser associated with a partner A may have a policy of always paying a higher fee than any competitors or specified competitors. Thus, transactions from partner A deploy advertisement objects from the current advertiser. However, advertisements are not necessarily deployed linearly. For example, advertisers may be classified at different priorities for time sharing of advertisement deployment by a particular partner. For example, priority 1 advertisers may have their advertisements supplied by a partner A 3 out of every 4 transactions, while priority 2 advertisers have access to 1 out of 4 transactions from the advertising partner.

Although FIGS. 12-15 depict population of the stores with new entities (i.e., new advertising partners and new advertisers), a similar set of operations is performed to update the stores for existing entities. Furthermore, although depicted in FIGS. 12-15 as being embodied separately, the functionality for collecting information, from both advertisers and advertising partners, and maintenance of the stores may be implemented in accordance with a variety of techniques. All of the functionality may be implemented as a single module on a single server, as computations (e.g., threads, processes, applications, etc.) distributed over multiple servers that operate on individual tasks or that operate cooperatively, etc. Some of the functionality may be implemented on clients, such as gathering of registration information. Therefore, it should be appreciated by those of ordinary skill in the art that the depicted examples are not intended to be limiting upon embodiments, but meant to aid in understanding the embodiments.

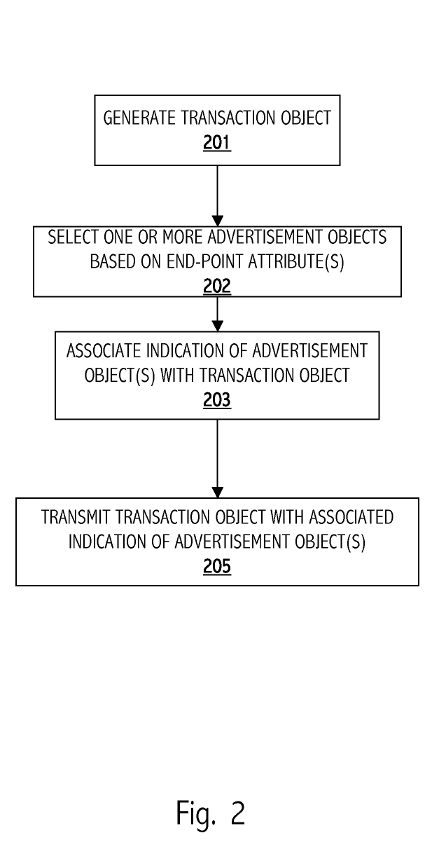

FIG. 2 depicts an example flowchart for end-point attribute based advertising. At block 201, a transaction object is generated (e.g., an PDF document, a word processing document, an e-mail message, a spreadsheet, etc.). At block 202, one or more advertisement objects are selected (automatically or manually) based on an attribute(s) of an end-point of the transaction. For example, advertisement objects are selected based on the address of either one or both of the source and destination end-points of the transaction, names of either one or both of the source and destination end-points of the transaction, geographic location of either one or both of the source and destination end-points, etc. Attributes of the transaction itself may also affect selection of advertisements objects. For example, certain advertisement objects are only available at particular times of day. Hence, if the transaction occurs outside of a given window of time, then the certain advertisement objects are not available for selection. At block 203, indication of an advertisement object (e.g., live link, file name, etc.) is associated (e.g., literally or referentially embedded) with the transaction object. At block 205, the transaction object is transmitted with the associated indications of advertisement object(s). Of course, transmission of the advertisement object and the transaction object is not necessarily over a network. For example, an advertisement object may be embedded in a PDF file, and the PDF file printed with the embedded advertisement object. The print out may then be mailed to the destination end-point.

Invoice Service

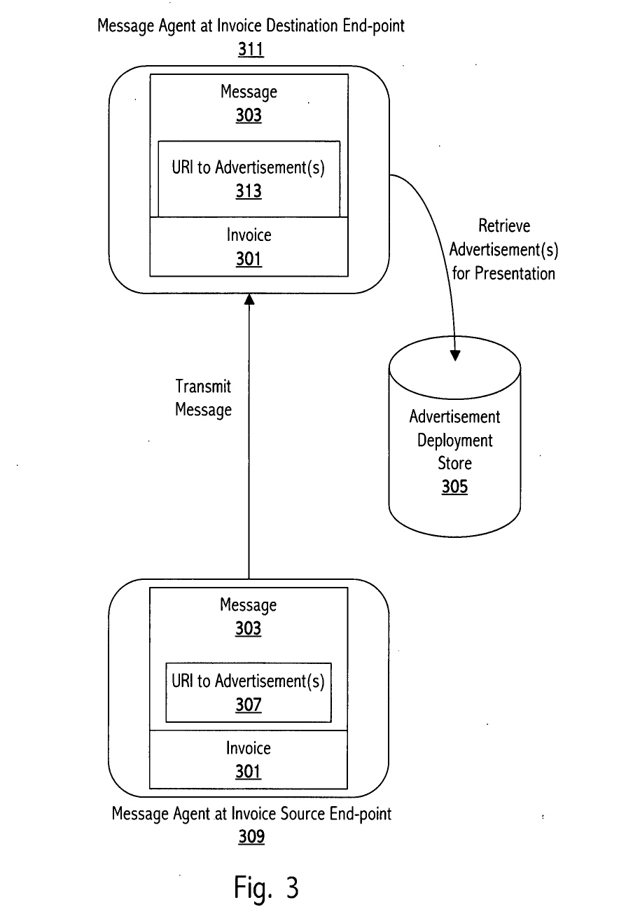

FIG. 3 depicts an example invoice transaction of an invoice-advertising service with referential embedding of an advertisement object. Vendors registered as advertising partners include advertisement objects with invoices (e.g., sent via e-mail, printed and sent via post, etc.). A message agent 309, such as an e-mail application, at a source end-point attaches an invoice 301 to a message 303. The message agent 309 also embeds a uniform resource identifier (URI) 307 in the message 303. The URI 307 may be a live URI The message agent 309 may be configured to automatically retrieve the URI 307 from a server of the invoice-advertising service. The URI 307 may be stored locally with respect to the message agent 309, and the message agent 309 configured to automatically embed the URI 307 in messages (e.g., the URI is set as a signature for messages composed by a particular set of identities and/or machines used for sending invoices, the URI is set as a signature for messages destined for any members of a particular group, etc.). The URI refers to one or more advertisement objects hosted in an advertisement store 305. The URI 307 encodes information that identifies the source end-point of this invoice transaction. For example, the URI 307 indicates a path in the advertisement store that corresponds to advertisement objects for the invoice transaction source end-point. The message 303 is transmitted with the attached invoice 301 to an invoice transaction destination end-point. A message agent 311 at the destination end-point receives the message 303, and accesses the advertisement store 305 to retrieve the one or more advertisement objects indicated by the embedded URI 307 (e.g., if the URI 307 is a live URI, the URI has been clicked by a user, etc.). The message agent 311 then presents the retrieved advertisement objects (or the advertisement objects are presented by an application other than the message agent 311). The message agent 311 displays the message 303 with the advertisement objects 313. Of course, the advertisement objects 313 may be locally cached, thus allowing access of the advertisement store 305 to be avoided (e.g., the advertisement objects 313 have been retrieved previously and then cached locally).

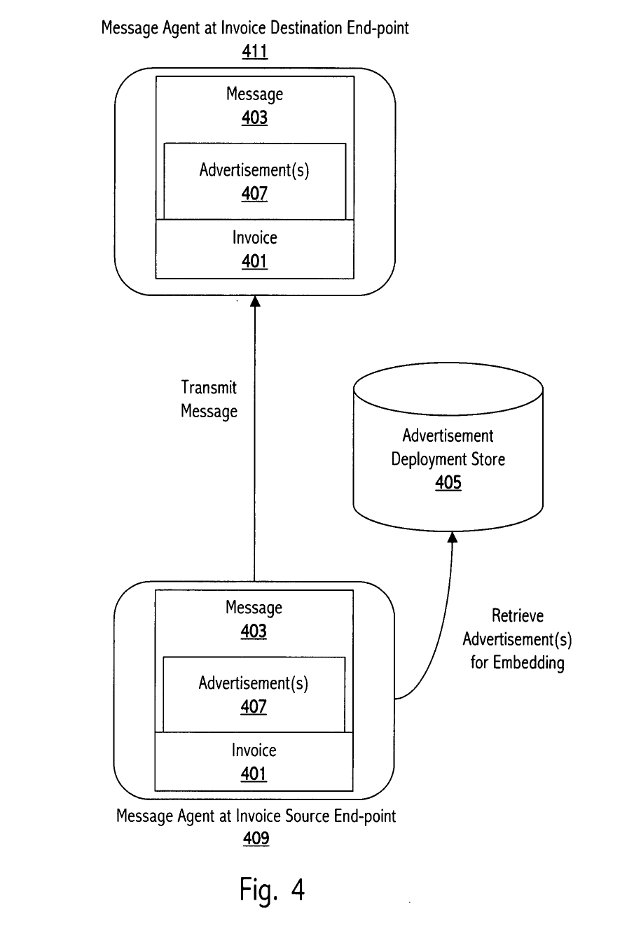

FIG. 4 depicts an example invoice transaction of an invoice-advertising service with literal embedding of an advertisement object. A message agent 409 at an invoice source end-point generates a message 403 and attaches an invoice 401 to the message 403. The message agent 409 is configured to retrieve one or more advertisement objects of the invoice source end-point from an advertisement store 405. The message agent 409 embeds the retrieved advertisement objects 407 into the message 403. The message 403 is then transmitted with the embedded advertisement objects 407 and the attached invoice 401 to an invoice destination end-point. A message agent at the invoice destination end-point allows display of the message 403 with the embedded advertisement objects 407.

Although FIGS. 3 and 4 depict literal embedding and referential embedding of advertisement objects into a message, embodiments are not so limited. The advertisement objects may be referentially or literally embedded in the invoice that is attached to a message. A message may be the invoice. Furthermore, literal and referential embedding techniques are not intended to be mutually exclusive techniques of conveying advertisement objects. A message may include advertisement objects and one or more URIs to additional advertisement objects. In addition, the advertisement objects may be associated with invoices elsewhere than the invoice source end-point. For example, outgoing invoices or messages conveying invoices may be transmitted to an invoice-advertising service. The invoice-advertising service associates advertisement objects of the invoice source end-point with received invoices or messages conveying invoices. After the association of one or more advertisement objects, the invoices continue to the invoice destination end-points. The invoice-advertising service would establish pass-through addresses for customers of the invoice source end-point. The invoice source end-point configures message agents to map addresses of customers to the pass-through addresses.

It should also be appreciated that advertisement objects may be selected or filtered based on more than source end-point. Other factors, such as time of day and destination end-point, may also affect the advertisement objects available to be associated with an invoice or invoice message.

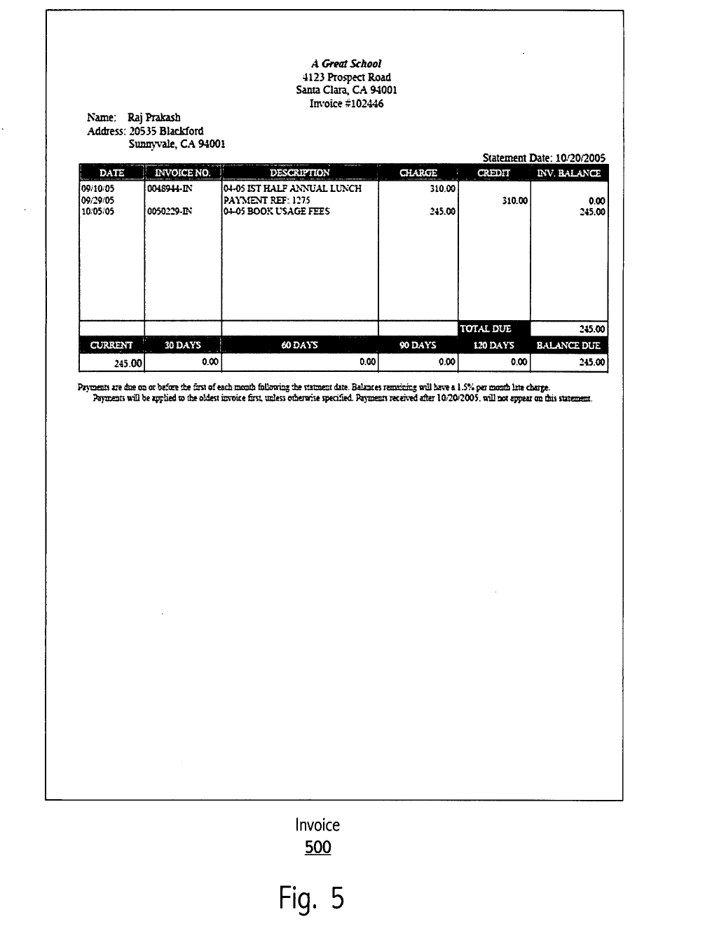

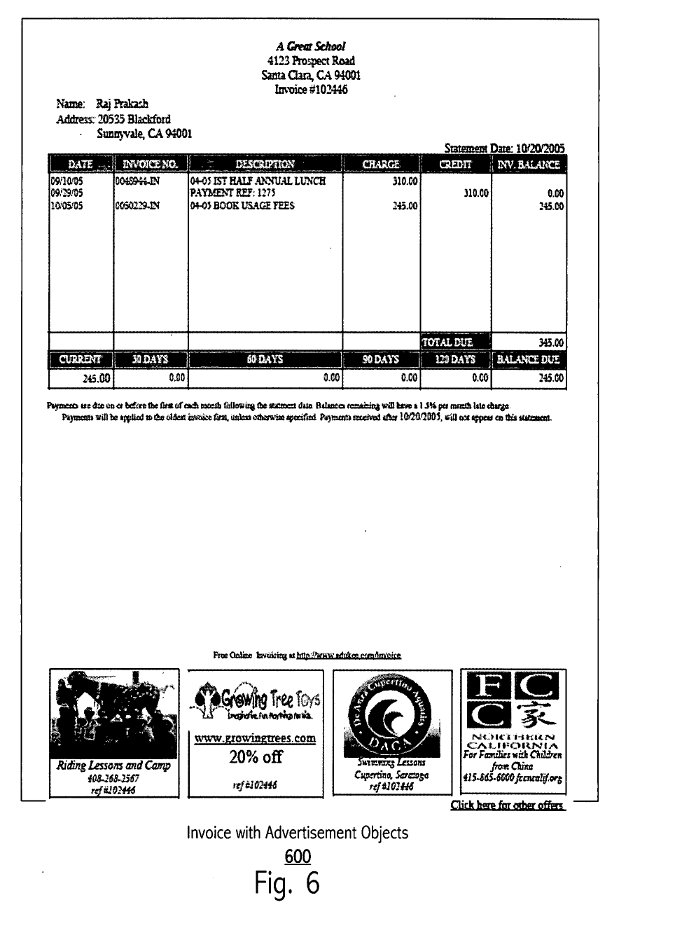

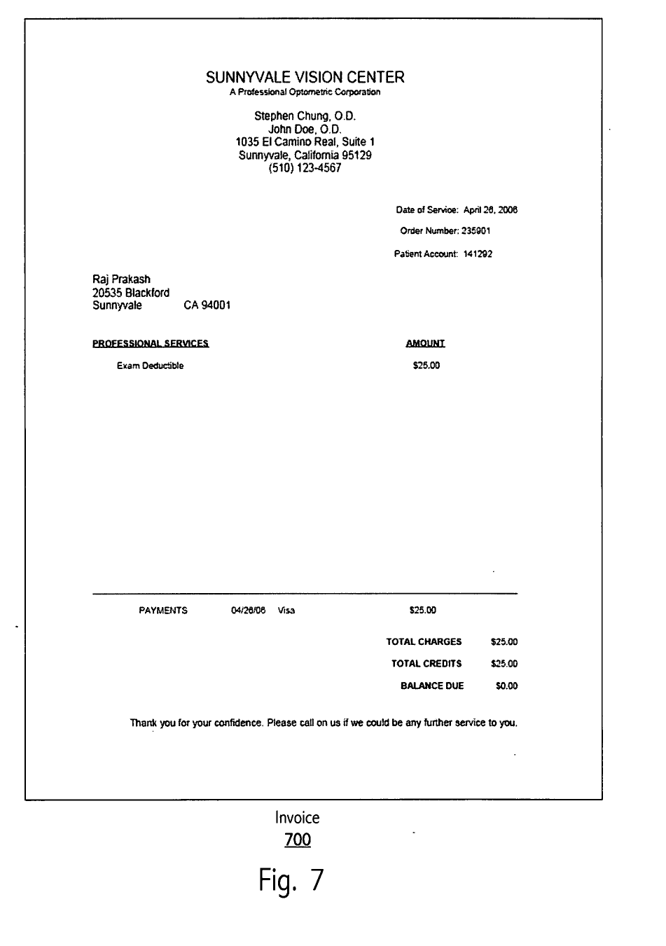

FIGS. 5 and 7 depict example invoices. FIGS. 6 and 8-9 depict example invoices with associated advertisement objects based on attributes of end-points. FIG. 5 depicts an example invoice from a school. An invoice 500 indicates a lunch charge, payment credit, and book usage fees. FIG. 6 depicts an example invoice from a school with embedded advertisement objects. An invoice 600 includes the invoice 500 and advertisements objects. The advertisement objects correspond to the school that originates the invoice (i.e., the source end-point). The advertisements objects in the invoice 600 include three images and an image with a link. A first advertisements object advertises riding lessons for children. A second advertisement object advertises a 20% discount for a toy business. A third advertisement object advertises swimming lessons. A fourth advertisement advertises services for families with Chinese children. This set of advertisement objects intelligently targets customers of the school with advertisements for products and services for families and children. In addition, the invoice 600 includes a link to other advertisement objects. Each of the advertisements objects also includes a reference number utilized to track the advertisements objects. For instance, a tracking structure that corresponds to the reference number indicated in an advertisement object is updated to track deployment of the corresponding advertisement object. In another instance, the reference number may be indicated in subsequent requests to view the advertisement object by a consumer downstream to track/measure exposure of the advertisement object.

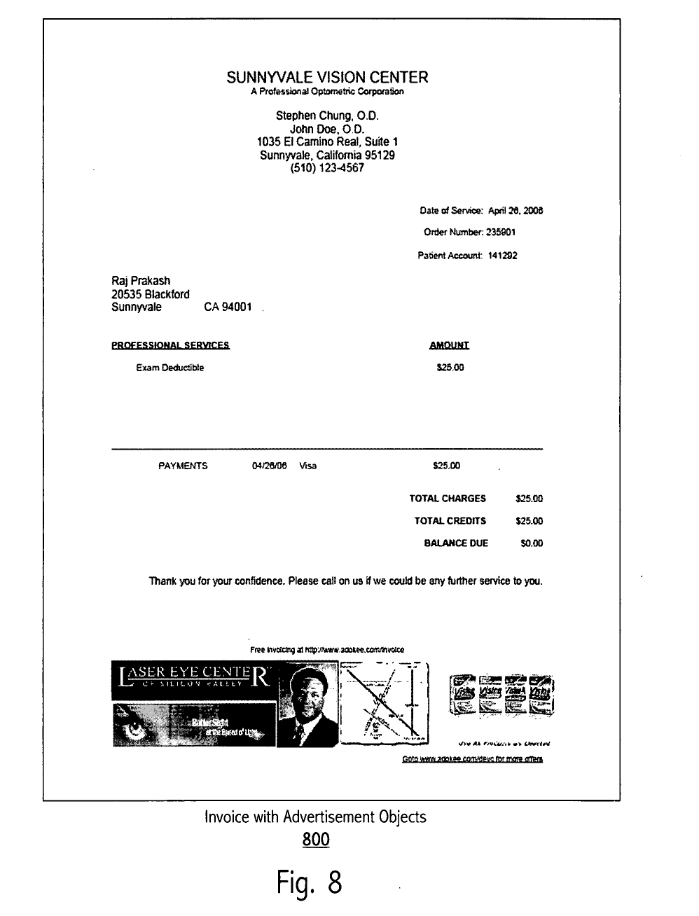

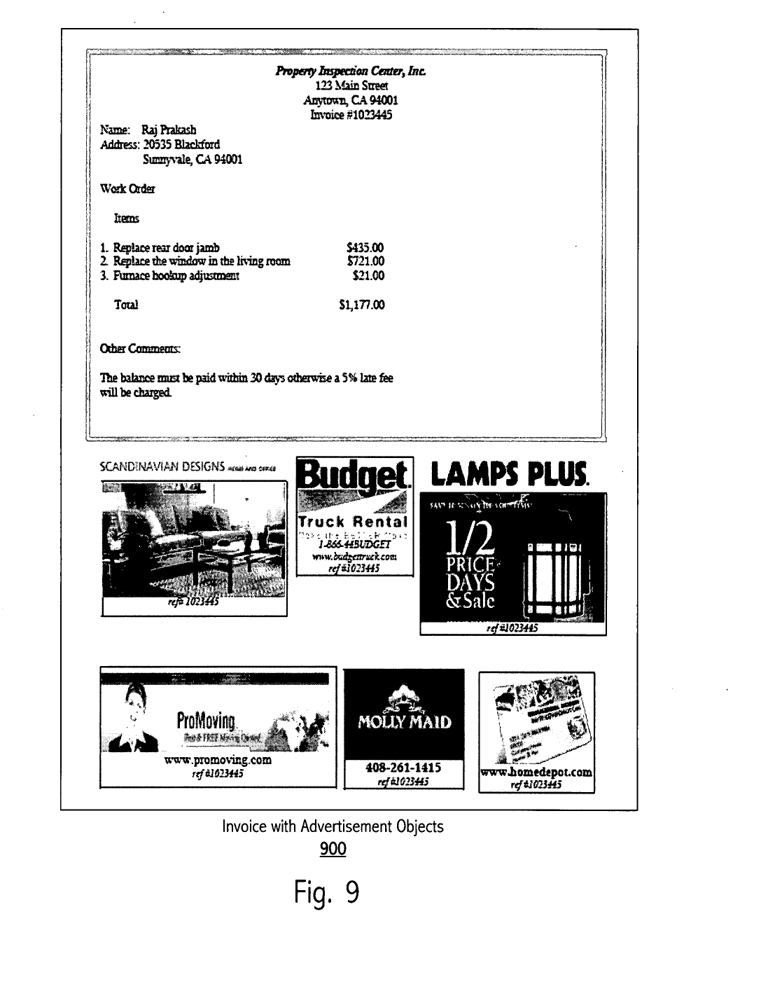

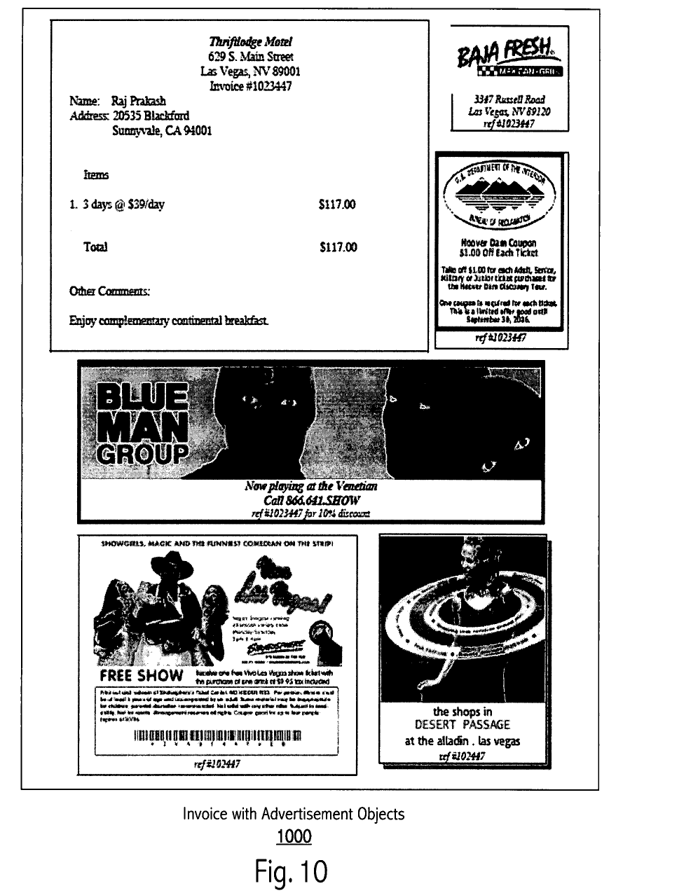

FIG. 7 depicts an example invoice for optometry services. An invoice 700 indicates charges for an eye exam and credits. FIG. 8 depicts an example optometrist invoice with advertisement objects embedded. An invoice 800 includes the invoice 700 and a set of advertisement objects directed at eye related services and products. The invoice 800 includes advertisements for a laser eye service center and eye treatment products. FIG. 9 depicts an example invoice from a property inspection center. An invoice 900 includes itemized charges for house repairs. The invoice 900 also includes advertisements for furniture, truck rental for moving, ½ off lamps, a moving service, a home improvement store, and a maid service. FIG. 10 depicts an example invoice for a motel. An invoice 1000 includes charges for a motel in Las Vegas, Nev., as well as a set of advertisements corresponding to the motel and location of the motel. The advertisements advertise restaurant, shopping, and entertainment options available in Las Vegas, perhaps, in close proximity to the motel.

Fee Structure

To encourage growth of a distributed advertising partnership network, user entities are rewarded based on deployed and/or viewed advertisements. The rewards may include any one or more of coupons, discounts, bartered services, service credits, cash, services, goods, etc. With various techniques, the advertising facilitation entity tracks the deployed and/or viewed advertisements that correspond to a particular user entity.

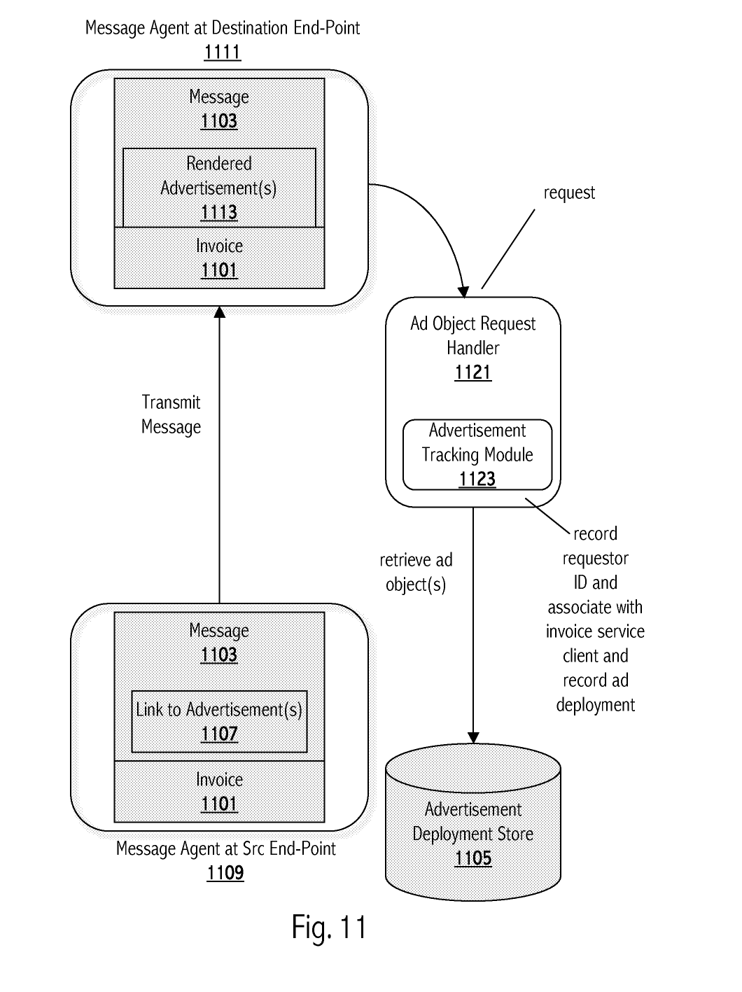

FIG. 11 depicts an example advertisement tracking mechanism. A message agent 1109 at a source-end point of an invoice transmits a message 1103, which includes an attached invoice 1101 and a link 1107 to one or more advertisement objects of the source end-point. The message 1103 is transmitted to a destination end-point. A message agent 1111 at the destination end-point receives the message. When the message 1103 is opened for display (or perhaps prior to the message being opened), the message agent 1111 (or a separate application or agent or a component of the message agent 1111) requests the set of advertisement objects represented by the link 1107 from an advertising facilitation entity. Of course as stated previously, the set of advertisement objects may not be automatically requested, but requested responsive to some event or action initiated by a user. An advertisement object request handler 1121 handles the request and retrieves the set of advertisement objects from an advertisement store(s) 1105. For example, the link 307 may be encoded as www.adokee.com/companyA/division3/advertisements. The handler 1121 retrieves all of the advertisements objects, or a given number of advertisement objects from the path indicated by the URI. In another example, the link 307 indicates an HTML file (www.adokee.com/companyA/division3/advertisements/ads2.html) that includes a set of advertisements as objects (e.g., XML objects).

An advertisement tracking module 1123 records identifying information from the request to track advertisement objects requested from the destination end-point. The identifying information may be validated to avoid abuse of the advertising partnership. For example, the identifying information is validated against information that identifies customers of the source end-point. If the identifying information cannot be validated, then various actions can be performed (e.g., request confirmation from the source end-point, deny access to the advertisement objects, allow access to the advertisement objects and indicate the destination end-point in a list of to-be confirmed requestors or suspicious requestors, etc.). In another example, recipient information in the message 1103 is encoded in the request and compared against source information indicated in the request to validate the requester. The advertisement tracking module 1123 also records the request to reward the user entity of the source end-point. For example, a number of requests is updated to reflect the current request. Such data may be maintained in the same path that hosts the advertisement objects, in a different path, in different stores, etc. The tracking may at a granularity of each advertisement object, each transaction, etc. When the time arrives for rewarding the user entity of the source end-point, the user entity may be rewarded in different currency (e.g., coupons, credits, money, etc.) based on attaining various levels of advertising deployment (e.g., a company is rewarded with 2 printer cartridge refills by a refill company if the advertisements for the refill company were accessed 100 times and 20 printer cartridge refills if accessed 300 times). The user entity may be rewarded $1 for each 10 accesses, 1% discounts for every 10 accesses, etc. A variety of compensation schemes can be envisioned that build upon the advertising partnership and tracking.

Moreover, various mechanisms can be used to deliver rewards. For example, a QuickReward mechanism may be employed to deliver rewards. For example, a coupon may indicate a 20% discount on a service or product if selected (e.g., clicking a button) within 5 minutes.

The described embodiments may be provided as a computer program product, or software, that may include a machine-readable medium having stored thereon instructions, which may be used to program a computer system (or other electronic device(s)) to perform a process according to embodiments of the invention, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

While the invention(s) is (are) described with reference to various implementations and exploitations, it will be understood that these embodiments are illustrative and that the scope of the invention(s) is not limited to them. In general, techniques for deploying advertisement objects based on end-point attributes throughout an advertising partnership network described herein may be implemented with facilities consistent with a variety of hardware, software, and database designs. Many variations, modifications, additions, and improvements are possible.

Furthermore, the above description refers to advertising based on end-point attributes. However, advertisements objects are not limited to being selected based on end-point attributes alone. Advertisements objects may also be selected for association with an object based on content of the object. For example, a receipt from an optometrist may indicate payment for an eye exam and contacts. Advertisements objects will not only be selected that are relevant to optometry, but also to contacts. Hence, at least one advertisement object associated with the receipt will be selected that specifically targets the content of the receipt indicating contacts (e.g., an advertisement object for a contact lens solution, special sales on contact lens cases, etc.). Various techniques may be implemented to harvest content information from an object of a transaction. Referring again to the example of a receipt from an optometrist, the receipt may be scanned after being generated and all or a select few of the harvested content information may be transmitted to the advertising network for selection of advertisement objects. Of course, the harvested content information may also be used to select advertisement object from a local cache of advertisement objects.

In addition, advertisement objects may also be selected based on attributes of the object being transmitted. When requesting or searching for advertisement objects, one or more indications of whether the object is a receipt, an invoice, a word processing document, a spreadsheet, an invoice spreadsheet, a PDF receipt, etc., is transmitted or utilized for selecting or locating one or more advertisement objects.

Although discussed in the context of transaction confirmation objects, advertisements may be deployed with other informational objects transmitted by a vendor. For instance, a vendor may produce a periodic newsletter or announcements for special events or occasions. The vendor may choose to have advertisements objects associated with the informational object.

A vendor may also deploy advertisement objects on web pages of the vendor. The advertisement objects, which are selected based on attributes of at least the vendor, may be displayed on a vendor home page or other web page of the vendor. In addition, the vendor may provide pages or space for members or customers. The advertisement objects selected based on vendor attributes may be displayed on these memory or customer web pages or space. For example, a vendor of a martial arts school may provide pages for students of the martial arts school. In addition to deploying advertisement objects with transactional objects and informational objects sent to the students, the advertisement objects (e.g., advertising martial arts equipment) are displayed on the student pages. Indeed, different advertisement objects may be displayed on the student pages based on the student activity or performance at the school, as well as activity on the personal student web page.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. An advertising network comprising:
a set of one or more stores hosting advertisement objects, advertiser information, advertising partner information, wherein advertiser information for an advertiser indicates one or more attributes of the advertiser and advertising partner information for an advertising partner indicates one or more attributes of the advertising partner; and
a first set of one or more servers communicatively coupled with the set of stores, the first set of servers,
installing and maintaining advertising partner entries, advertisement objects, and advertiser entries in the set of stores,
installing and maintaining advertisement object deployment entries in the set of stores, wherein the advertisement object deployment entries associate advertisement objects with advertising partners based, at least in part, on the advertising partner information, and
deploying advertisement objects for transactions initiated by vendors registered as advertising partners indicated in the set of stores.

2. The advertising network of claim 1, wherein at least one of the set of one or more servers transmit advertisement objects to local stores of respective associated registered vendors.

3. The advertising network of claim 1, wherein at least one of the set of servers supply, responsive to a request from a registered vendor, a set of one or more advertisement objects associated with the vendor.

4. The advertising network of claim 1, wherein at least one of the set of servers receives a vendor transaction object from a vendor destined for a customer and modifies the transaction object to indicate a set of one or more advertisement objects associated with the vendor.

5. The advertising network of claim 4 further comprising the at least one server forwarding the modified transaction object to the customer of the vendor.

6. The advertising network of claim 1, wherein a transaction initiated by registered vendor comprises delivery of at least one of a receipt and an invoice.

7. A method of deploying advertisements, the method comprising:
selecting a set of one or more advertisements objects from a set of one or more remote stores based on an attribute of a vendor indicated in the set of remote stores;
automatically associating at least a subset of the selected set of advertisement objects with a vendor transaction object of the vendor;
supplying the associated subset of advertisement objects with the vendor transaction object from the vendor to one or more customers of the vendor.

8. The method of claim 7, wherein the vendor transaction object is selected from a set consisting essentially of a receipt, a purchase order, an invoice, a newsletter, and a vendor announcement.

9. The method of clam 7, wherein the automatically associating comprises embedding the subset of advertisement objects in one of the vendor transaction object and a message carrying the vendor transaction object.

10. The method of claim 7, wherein the subset of advertisement objects comprise one or more of video, audio, multimedia, an image, text, script, and a referential indication.

11. The method of claim 10, wherein the referential indication is selected from a set that consists essentially of a referential indication and a literal indication.

12. The method of claim 11, wherein the referential indication includes a uniform resource identifier.

13. The method of claim 7, wherein the attribute is selected from a set consisting essentially of category of business, type of business, product offered by the vendor, service offered by the vendor, physical location of the vendor, hours of operation of the vendor, and name of the vendor.

14. The method of claim 7, wherein the supplying comprises one of printing and mailing, electronically transmitting, and printing and delivering directly.

15. The method of claim 7 further comprising tracking one or more of utilization and access of the associated subset of advertisements objects.

16. The method of claim 15, further comprising identifying purchases that follow from the set of one or more advertisements objects.

17. The method of claim 7 further comprising rewarding vendors based, at least in part, on supplied advertisement objects.

18. A method comprising the acts of:
storing information about a first vendor;
storing information about a second vendor and storing an advertisement object for the second vendor;
selecting the advertisement object based on the information about the first vendor and the second vendor; and
supplying the selected advertisement object.

19. The method of claim 18, wherein the transaction object is selected from a set consisting essentially of a purchase order, a receipt, an invoice, a vendor announcement to customers of the first vendor, and a newsletter of the first vendor.

20. The method of claim 18 further comprising the acts of:
tracking customer utilization of the advertisement object; and
compensating the first vendor based on the tracked customer utilization of the advertisement object.

21. The method of claim 18 further comprising the acts of generating the transaction object and automatically indicating the selected advertisement object in the transaction object.

22. A method of intelligently deploying advertisement objects, the method comprising the acts of:
generating a transaction object for a first vendor;
selecting a set of advertisement objects based on information about the first vendor and information about the set of advertisement objects that correspond to a set of vendors registered with an advertising partnership network that maintains the advertisement objects;
automatically associating the set of advertisement objects with the generated transaction object;
transmitting the transaction object and the set of advertisement objects to one or more customers of the first vendor.

23. The method of claim 22, wherein the transaction object is selected from a set consisting essentially of a purchase order, a receipt, a newsletter of the first vendor, an announcement of the first vendor, and an invoice.

24. The method of claim 22 further comprising:
tracking customer utilization of the set of advertisement objects;
charging those of the set of vendors represented by utilized ones of the set of advertisement objects as indicated by the tracking; and
compensating the first vendor based on the tracked customer utilization of the set of advertisement objects.

25. A method of associating vendors for advertisement deployment, the method comprising:
registering a first vendor as an advertising partner vendor that participates in a transaction object generation service;
registering a second vendor as an advertising vendor and storing one or more advertisement objects for the second vendor and information about the advertisement objects;
recording policy information for the second vendor, wherein the policy information governs deployment of the one or more advertisement objects of the second vendor; and
selecting at least one of the set of advertisement objects for transmission with a transaction object of the first vendor, wherein the at least one of the set of advertisement objects is selected based, at least in part, on information about the first vendor and the information about the selected at least one of the set of advertisement objects.

26. The method of claim 25, wherein the transaction object is selected from a set consisting essentially of a purchase order, receipt, invoice, newsletter, and announcement for the first vendor.
